(19) United States
(12) Patent Application Publication
(10) Pub. No.: US 2017/0060871 A1
(43) Pub. Date: Mar. 2, 2017

(54) GROUP-BASED ATTENTION MANAGEMENT

(71) Applicant: International Business Machines Corporation, Armonk, NY (US)

(72) Inventors: Paul R. Bastide, Boxford, MA (US); John M. Boyer, Victoria (CA); Matthew E. Broomhall, Goffstown, NH (US); Robert E. Loredo, North Miami Beach, FL (US)

(21) Appl. No.: 14/835,277

(22) Filed: Aug. 25, 2015

(51) Int. Cl. G06F 17/30; H04L 12/58

(52) U.S. Cl. CPC G06F 17/3053; H04L 51/16; H04L 51/26

(57) ABSTRACT

A method for providing group-based attention management of electronic messages may include receiving an electronic message, the electronic message defining a plurality of recipients. One or more candidate tuples are then identified from the plurality of recipients. The one or more candidate tuples are compared with one or more stored tuples to identify one or more relevant tuples from the candidate tuples. Based on the one or more relevant tuples, an attention score for one or more of the plurality of recipients is determined. Based on the attention score for one or more of the plurality of recipients, the presentation of the electronic message to one or more of the plurality of recipients is modified.

### BACKGROUND

Aspects of the present invention relate to a system for providing group-based attention management. In this regard, a need exists for an improved system for providing group-based attention management.

### SUMMARY

In one aspect, the present invention embraces a method for providing group-based attention management of electronic message and an associated system and computer program product.

In one embodiment, the method includes receiving an electronic message, the electronic message defining a plurality of recipients. One or more candidate tuples are then identified from the plurality of recipients. The one or more candidate tuples are compared with one or more stored tuples to identify one or more relevant tuples from the candidate tuples. Based on the one or more relevant tuples, an attention score for one or more of the plurality of recipients is determined. Based on the attention score for one or more of the plurality of recipients, the presentation of the electronic message to one or more of the plurality of recipients is modified.

In some embodiments, comparing the one or more candidate tuples with one or more stored tuples to identify one or more relevant tuples from the candidate tuples is based on comparing members of the one or more candidate tuples to members of the one or more stored tuples.

In some embodiments and in combination with any of the above embodiments, comparing the one or more candidate tuples with one or more stored tuples to identify one or more relevant tuples from the candidate tuples is based on analyzing a message history associated with the one or more stored tuples.

In some embodiments and in combination with any of the above embodiments, comparing the one or more candidate tuples with one or more stored tuples to identify one or more relevant tuples from the candidate tuples is based on determining whether a tuple participation index associated with the one or more stored tuples exceeds a threshold.

In some embodiments and in combination with any of the above embodiments, determining an attention score for one or more of the plurality of recipients is based on analyzing a message history associated with members of the one or more relevant tuples.

In some embodiments and in combination with any of the above embodiments, determining an attention score for one or more of the plurality of recipients is based on analyzing an interaction history between members of the one or more relevant tuples and a sender of the electronic message.

In some embodiments and in combination with any of the above embodiments, wherein determining an attention score for one or more of the plurality of recipients is based on (i) performing natural language processing of the electronic message and/or (ii) analyzing message metadata associated with the electronic message.

In some embodiments and in combination with any of the above embodiments, the method includes, based on the one or more relevant tuples, determining a confidence score of each attention score for one or more of the plurality of recipients; wherein modifying the presentation of the electronic message to one or more of the plurality of recipients is further based on the confidence score of each attention score for one or more of the plurality of recipients.

In some embodiments and in combination with any of the above embodiments, modifying the presentation of the electronic message to one or more of the plurality of recipients comprises increasing a message priority for a first recipient and decreasing a message priority for a second recipient.

In some embodiments and in combination with any of the above embodiments, the method includes determining that a message volume exceeds a threshold; wherein, based on determining that the message volume exceeds a threshold, (i) determining an attention score for one or more of the plurality of recipients is further based on secondary criteria and/or (ii) modifying the presentation of the electronic message to one or more of the plurality of recipients is further based on the secondary criteria.

### BRIEF DESCRIPTION OF THE DRAWINGS

The present invention is further described in the detailed description which follows in reference to the noted plurality of drawings by way of non-limiting examples of embodiments of the present invention in which like reference numerals represent similar parts throughout the several views of the drawings and wherein:

FIG. 1 depicts an exemplary method for providing group-based attention management of electronic messages in accordance with an embodiment of the present invention.

FIG. 2 is a block schematic diagram of an exemplary system for providing group-based attention management of electronic messages in accordance with an embodiment of the present invention.

### DETAILED DESCRIPTION

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

As used herein, “electronic messages” refer to any type of electronic message, including an instant message, an email message, a social media message, a social media posting, or any other type of social media message or content.

As used herein, a “tuple” refers to a plurality of recipients of an electronic message. The members of a tuple may be all of the recipients of an electronic message or may be a subset of the recipients of an electronic message.

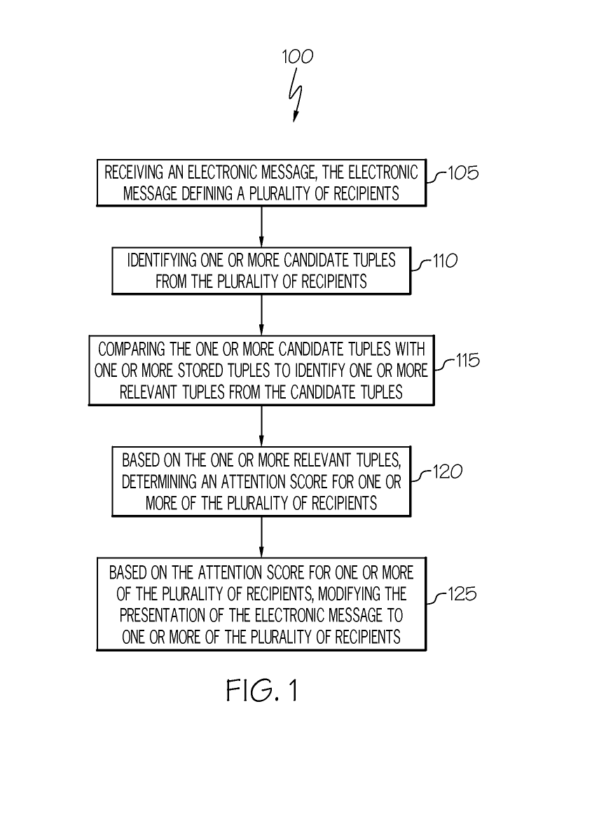

In one aspect, the present invention embraces a method for providing group-based attention management of electronic messages. In this regard, FIG. 1 depicts an exemplary method 100 for providing group-based attention management of electronic messages, which may be performed by an attention management system.

Accordingly, at block 105, an electronic message is received. The electronic message typically defines a plurality of recipients. For example, the header of an email may define primary recipients that the email is sent to. An email may also define secondary recipients (e.g., recipients that are carbon copied or blind carbon copied). In some embodiments, a social media posting or other content may define recipients based on such recipients being mentioned or tagged in such social media posting or other content. In other embodiments, a recipient may be anyone to whom social media content may be displayed. For example, recipients of a social media posting may have a particular social media relationship with the sender (e.g., poster and/or author of social media content). Typically, the social network relationship is based on the degree of the relationship between a recipient and the sender within a particular social network. In this regard, two users would have a first degree relationship if they are directly connected (e.g., are friends) within a social network, and two users would have a second degree relationship if they are not directly connected, but share a mutual connection (e.g., a mutual friend) within a social network. In other embodiments, the social network relationship may be based on: whether or not two users are members of the same group with a social network, common interests between two users, similar user profiles within a social network, or any other commonality between two users within a social network.

At block 110, one or more candidate tuples are identified from the plurality of recipients. The candidate tuples may be all possible tuples that could be generated from the recipients of the electronic message. For example, if an electronic message defines the following recipients: Recipient 1, Recipient 2, and Recipient 3, there may be four candidate tuples: (i) Recipient 1 and Recipient 2, (ii) Recipient 1 and Recipient 3, (iii) Recipient 2 and Recipient 3, and (iv) Recipient 1, Recipient 2, and Recipient 3. By way of further example, if an electronic message defines the following recipients: Recipient 1, Recipient 2, Recipient 3, and Recipient 4, there may be eleven candidate tuples: (i) Recipient 1 and Recipient 2, (ii) Recipient 1 and Recipient 3, (iii) Recipient 2 and Recipient 3, (iv) Recipient 1 and Recipient 4, (v) Recipient 2 and Recipient 4, (vi) Recipient 3 and Recipient 4, (vii) Recipient 1, Recipient 2, and Recipient 3, (viii) Recipient 1, Recipient 2, and Recipient 4, (ix) Recipient 2, Recipient 3, and Recipient 4, (x) Recipient 1, Recipient 3, and Recipient 4, and (xi) Recipient 1, Recipient 2, Recipient 3, and Recipient 4.

In some embodiments, there may be a defined maximum size of the candidate tuples. For example, if an electronic message defines the following recipients: Recipient 1, Recipient 2, Recipient 3, and Recipient 4 and a maximum tuple size of three, there may be ten candidate tuples: (i) Recipient 1 and Recipient 2, (ii) Recipient 1 and Recipient 3, (iii) Recipient 2 and Recipient 3, (iv) Recipient 1 and Recipient 4, (v) Recipient 2 and Recipient 4, (vi) Recipient 3 and Recipient 4, (vii) Recipient 1, Recipient 2, and Recipient 3, (viii) Recipient 1, Recipient 2, and Recipient 4, (ix) Recipient 2, Recipient 3, and Recipient 4, and (x) Recipient 1, Recipient 3, and Recipient 4.

At block 115, the candidate tuples are compared against one or more stored tuples to thereby identify one or more relevant tuples from the candidate tuples. Typically, the relevant tuples are identified by comparing the members of the candidate tuples with the members of the stored tuples to determine if there is a match between the members of a candidate tuple and the members of a stored tuple. In one embodiment, the relevant tuples include each candidate tuple having a matching stored tuple.

In some instances the candidate tuples may not identically match any stored tuples. In such instances, the relevant tuples may be the candidate tuple(s) having the closest (but not identically) matching stored tuples. In this regard, greatest subset algorithms, dense-k subgraphs, or clustering algorithms may be used to determine which candidate tuples have the closest matching stored tuples.

In some embodiments, identifying one or more relevant tuples is further based on a message history associated with the stored tuples. In this regard, the relevant tuples include candidate tuples having a matching (or sufficiently matching) stored tuple that has a sufficiently relevant message history. For example, if a candidate tuple matches a stored tuple, but the stored tuple has an insufficiently relevant message history, then that candidate tuple may not be identified as a relevant tuple. That said, if a candidate tuple matches a stored tuple, and the stored tuple has a sufficiently relevant message history, then that candidate tuple may be identified as a relevant tuple. In some embodiments, the relevant tuple may be the candidate tuple having a matching (or sufficiently matching) stored tuple that has the most relevant message history.

In some embodiments, the relevance of the message history of a stored tuple may be based on the quantity of messages previously received by the stored tuple (e.g., a stored tuple that has a history of receiving a large volume of messages would be more relevant than a stored tuple that has only received a few previous messages). In some embodiments, the relevance of the message history of a stored tuple may be based on whether one or more members of a stored tuple have a history of responding to or otherwise interacting with messages directed to such stored tuple (e.g., a stored tuple that has a history of its members responding to messages would be more relevant than a stored tuple whose members have not responded to previous messages).

In some embodiments, each of the stored tuples may define a tuple participation index, which is a score that reflects the message history associated with each stored tuple. The tuple participation index for a stored tuple may reflect the number of messages received that are associated with the stored tuple or the number of messages associated with the stored tuple with which a member of the stored tuple has interacted. The tuple participation index for the stored tuples may be updated on a regular basis (e.g., monthly, weekly, daily, or per received message) or intermittent basis by analyzing the message history associated with the stored tuples. In some embodiments, the tuple participation index for the stored tuples may be updated in near real time based on messages being received or a tuple member interacting with a message.

In some embodiments, the stored tuples may be predefined. In other embodiments, the stored tuples may be created through analyzing messages associated with a messaging system. In this regard, a message may be analyzed to determine if the recipients of the message correspond to any existing stored tuples. If the recipients of the message correspond to an existing stored tuple, the message history of the stored tuple may be updated to reflect that the stored tuple is associated with another received message (e.g., by incrementing a tuple participation index associated with the stored tuple). If the recipients of the message do not correspond to an existing stored tuple, a new stored tuple may be created any stored. The stored tuples and any associated message history may be stored in a data structure, such as a look-up table, map, or multiple edge graph structure.

In some embodiments, messages associated with a messaging system may be analyzed on a regular basis (e.g., monthly, weekly, or daily) or intermittent basis. In some embodiments, messages associated with a messaging system may be analyzed in near real time (e.g., as the messages are received and/or interacted with). The message history analyzed to identify the relevant tuples and/or establish stored tuples may be from a defined time period, such as the most recent month or year. Accordingly, a stored tuple may expire if there is insufficient recent message history associated with such stored tuple.

In some embodiments, the candidate tuples, stored tuples, and/or relevant tuples may be limited to recipients that are part of the same domain or organization. The candidate tuples, stored tuples, and/or relevant tuples may be identified from the perspective of all users of a messaging system or from the perspective of a particular user of a messaging system.

Once the relevant tuples have been identified, at block 120, an attention score for one or more of the plurality of recipients (e.g., one or more members of the relevant tuple(s)) is determined. The attention score for a recipient typically reflects how well the recipient is suited to respond to or otherwise interact with (e.g., forward) the electronic message.

Typically, determining an attention score for one or more of the plurality of recipients is based at least in part on analyzing the message history associated with members of the one or more relevant tuples. For example, the message history associated with the members of the one or more relevant tuples may be analyzed to determine whether each member has a history of interacting with messages directed to the relevant tuple. A member having a history of responding to previous messages will typically have a higher attention score than a member that has not responded to previous messages. In some embodiments, the message history associated with the members of the one or more relevant tuples may be analyzed to determine whether each member has a history of interacting with messages directed to the relevant tuple by the sender of the current electronic message.

In some embodiments, a stored tuples may define a member participation index for each member of the stored tuple, which is a score that reflects the extent to which each member of the stored tuple has interacted with prior messages directed to such stored tuple. The member participation index for a member of a stored tuple may be incremented each time such member interacts with a message (e.g., by replying to or forwarding a message). The member participation index for members of the stored tuples may be updated on a regular basis (e.g., monthly, weekly, or daily) or intermittent basis by analyzing the message history associated with the stored tuples. In some embodiments, the member participation index for the members of the stored tuples may be updated in near real time based on a tuple member interacting with a message. The attention score for one or more of the members of a relevant tuple may be or may be based on the member participation index for members of a corresponding stored tuple.

The attention score for one or more of the plurality of recipients may be based at least in part on performing natural language processing of the electronic message to assess the meaning and value of content within the electronic message. For example, the electronic message may be searched for contextual key words and/or phrases that may be of interest to a member of a relevant tuple. Such key words and/or phrases may relate to topics predefined as being of interest to a member of a corresponding stored tuple or topics identified as being of interest to a member of a corresponding stored tuple based on analyzing prior messages interacted with by such member.

The attention score for one or more of the plurality of recipients may be based at least in part on analyzing the electronic message to determine if the electronic message is directly addressed to one or more of the recipients. For example, natural language processing of the message may be performed to determine if the name of any of the recipients appears in the content of the electronic message. A recipient whose name appears in the content of the electronic message may have a higher attention score, than a recipient whose name does not appear in the content of the electronic message. Message metadata may also be analyzed to determine if the electronic message is directly addressed to one or more of the recipients. For example, a recipient specified in the “To:” header field of an email may have a higher attention score than a recipient specified in the “Cc:” or “Bcc:” header fields of the email.

At block 125, based on the attention score for one or more of the recipients, the presentation of the electronic message to one or more of recipients is modified. As used herein, modifying the presentation of the electronic message includes any way of altering how the electronic message is displayed to one or more recipients (e.g., via a graphical user interface (GUI) provided to a recipients computing device, such as a computer, laptop, tablet computer, or mobile phone). In this regard, if a recipient has a relatively high attention score (e.g., as compared against other recipients or against a defined threshold) for an electronic message, then the display of the electronic message be altered to increase the priority of the electronic message to the recipient. For example, if a recipient has a relatively high attention score, an electronic message may be highlighted, bolded, colored, or otherwise altered to emphasize the importance of the electronic message to the recipient when displayed to the recipient. If a recipient has a relatively low attention score (e.g., as compared against other recipients or against a defined threshold) for an electronic message, then the display of the electronic message may be altered to decrease the priority of the electronic message to the recipient, such as by collapsing the electronic message, graying out the electronic message, removing the electronic message from the display, or otherwise altering the electronic message to deemphasize the importance of the electronic message. In some embodiments, the order of electronic messages displayed to a recipient may be altered based on the recipient's attention scores for the electronic messages (e.g., to display electronic messages with the highest attention scores first). If an attention score for a particular recipient is not calculated, then the display of an electronic message to that recipient is typically not modified.

In some embodiments, modifying the presentation of the electronic message to one or more of recipients may be further based on determining a confidence score for the attention scores of the recipients of the electronic message. In this regard, a confidence score may be calculated for one of more of the determined attention scores to reflect a confidence in whether the attention scores correctly reflects to which recipients an electronic message should be important or unimportant. For example, the confidence score may be low if the attention scores are calculated based on a relatively small sample of message history. If a confidence score is sufficiently low (e.g., below a threshold), then the presentation of an electronic message to the recipients might not be altered or may be differently altered. For example, if a confidence score is high, an electronic message may be removed from the display of a recipient having a low attention score, but if the confidence score is low, the electronic message may be grayed-out in the display of the recipient rather than removed.

In some embodiments, modifying the presentation of the electronic message to one or more of recipients may be further based on receiving information that a particular recipient is unavailable. For example, if a recipient has an unavailable or out-of-office status in a messaging system, the importance of the electronic message may be decreased for such recipient, but increased for other recipients.

In one embodiment, if a message volume associated with a messaging system or a particular recipient exceeds a threshold, fewer messages may be emphasized to recipients as being important. For example, determining an attention score for one or more of the plurality of recipients and/or modifying the presentation of the electronic message to one or more of the plurality of recipients may be further based on secondary criteria. In a particular example, during periods of low message volumes, determining attention scores and modifying the presentation of electronic messages may be based on a member participation index for members of corresponding stored tuples, but, during periods of high message volumes, determining attention scores and/or modifying the presentation of electronic messages may be additionally based on whether a message topic or message metadata is associated with a particular recipient. By way of further example, during periods of high message volume, higher attention scores (as compared to periods of lower message volume) may be required before the importance of a message is emphasized. Moreover, during periods of high message volume, messages with low attention scores might not be display to recipients, rather than being grayed out.

As evident from the preceding description, an attention management system in accordance with the present invention represents an improvement in technology by emphasizing or deemphasizing the importance of electronic messages to recipients. Indeed, the system typically emphasizes or deemphasizes electronic messages being displayed to recipients, rather than displaying all messages as having the same priority. Moreover, by emphasizing or deemphasizing the importance of electronic messages to members of a group of recipients, the attention of a relevant group member may be drawn to the message without drawing the attention of group members who may be less interested in the message. Accordingly, the system provides a technical solution for overcoming the problem of recipients receiving more messages than they can realistically consume, which can result in the recipients overlooking important messages. The system allows a recipient to easily identify important messages, without having to review unimportant messages.

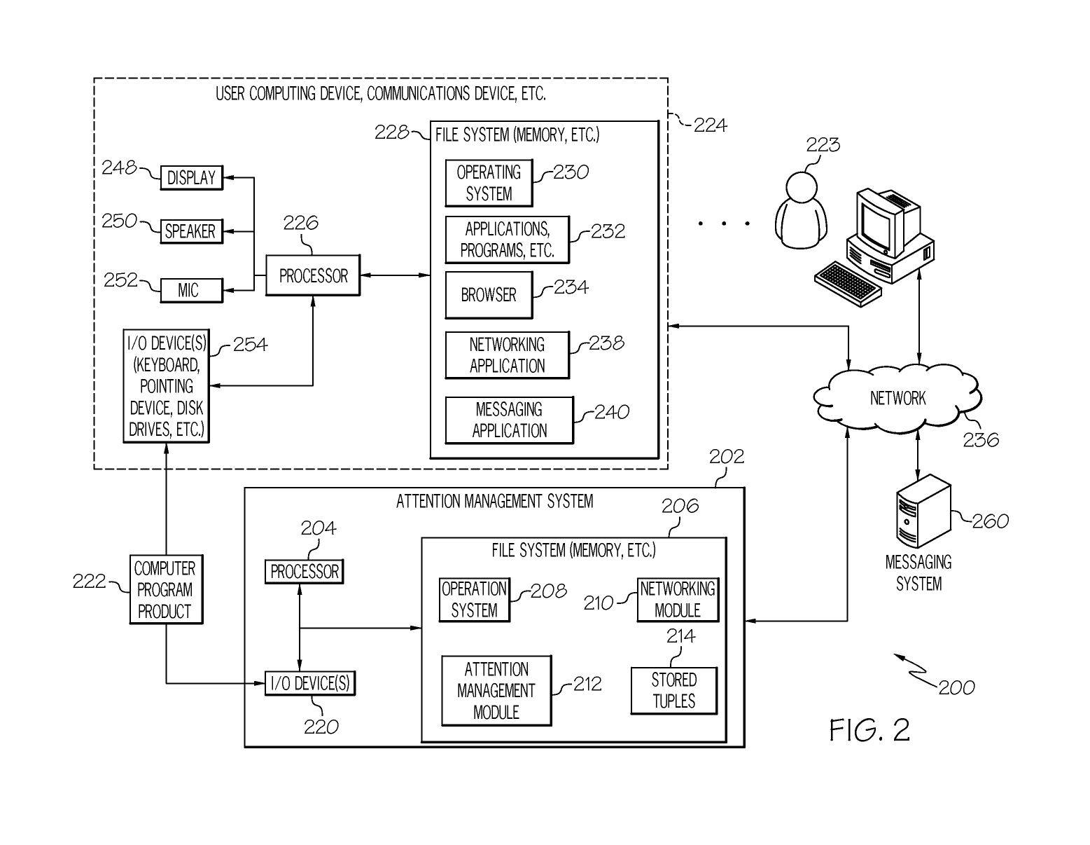

FIG. 2 is a block schematic diagram of an example of a system 200 for providing group-based attention management of electronic messages in accordance with an embodiment of the present invention. The method 100 of FIG. 1 may be embodied in and performed by the system 200. The system 200 may include an attention management system 202. The attention management system 202 may be a server or similar processing device. The attention management system 202 may include a processor 204 for controlling operation of the attention management system 202 for performing functions, such as those described herein with respect to providing group-based attention management of electronic messages. The attention management system 202 may also include a file system 206 or memory. An operating system 208, applications and other programs may be stored on the file system 206 for running or operating on the processor 204. A networking module 210 or system may also be stored on the file system 206 and may be compiled and run on the processor 204 to perform the function of allowing the attention management system 202 to communicate with other devices similar to those described herein. The networking module 210 may be any type of online communications mechanism for online communications or conversations.

An attention management module 212 or system may also be stored on the file system 206. The method 100 of FIG. 1 may be embodied in the attention management module 212 and may be performed by the processor 204 when the attention management module 212 is compiled and run on the processor 204. The attention management module 212 may operate in association with the networking module 210 and other types of communications media to perform the functions and operations associated with the method 100. In another embodiment, the attention management module 212 may be a component of the networking module 210 and may operate in association with the networking module 210 and other communications media.

Stored tuples 214 may also be stored on the file system 206. In addition, information related to message history may be stored in the file system 206, such as a tuple participation index associated with each stored tuple 214 and/or a member participation index for each member of the stored tuples 214.

The attention management system 202 may also include one or more input devices, output devices or combination input/output devices, collectively I/O devices 220. The I/O devices 220 may include, but are not necessarily limited to, a keyboard or keypad, pointing device, such as a mouse, disk drive and any other devices to permit a user to interface with and control operation of the attention management system 202 and to communicate with other devices and systems. For example, the attention management system 202 may communicate with a messaging system 260 to retrieve electronic messages, retrieve message history information, and/or direct how electronic messages are displayed to recipients. In some embodiments, the attention management system 202 may be a component of the messaging system 260. The messaging system may be an email system or a social networking system. At least one of the I/O devices 220 may be a device to read a computer program product, such as computer program product 222. The computer program product 222 may be similar to that described in more detail herein. The networking module 210 and the attention management module 212 may be loaded on the file system 206 from a computer program product, such as computer program product 222.

A user 223 (e.g. a recipient or sender) may use a computing device 224 or communications device to access the attention management system 202, networking module 210 or attention management module 212. The computing device 224 or communications device may be any sort of communications device, including a mobile or handheld computer or communications device. The computing device 224 may include a processor 226 to control operation of the computing device 224 and a file system 228, memory or similar data storage device. An operating system 230, applications 232 and other programs may be stored on the file system 228 for running or operating on the processor 226. A web or Internet browser 234 may also be stored on the file system 228 for accessing the attention management system 202 and/or the messaging system 260 via a network 236. The network 236 may be the Internet, an intranet or other private or proprietary network.

A networking application 238 for may also be stored on the file system 228 and operate on the processor 226 of the computing device 224.

In accordance with an embodiment, a messaging application 240 may also be stored on the file system 228. Aspects of the method 100 in FIG. 1 may be embodied and performed by the messaging application 240. In accordance with another embodiment, the messaging application 240 may be part of the networking application 238.

The messaging application 240 operating on the computing device 224 may interface with or operate in conjunction with the attention management module 212 on the attention management system 202 to perform the functions and operations described herein for providing group-based attention management of electronic messages. Accordingly, the messaging application 240 operating on the computing device 224 may perform some of the functions and operations of the method 100 and the attention management module 212 operating on the attention management system 202 may perform other functions of the method 100. Some embodiments of the present invention may include only the attention management module 212 operating on the attention management system 202, and other embodiments may include only the messaging application 240 operating on the computing device 224. In some embodiment, the web or Internet browser 234 may interface with or operate in conjunction with the attention management module 212 on the attention management system 202 to perform the functions and operations described herein for performing attention management of electronic messages.

The computing device 224 may also include a display 248, a speaker system 250, and a microphone 252 for voice communications. One or more user interfaces may be presented on the display 248 for controlling operation of the computing device 224 (e.g., for controlling operation of the networking application 240) and for performing the operations and functions described herein.

The computing device 224 may also include one or more input devices, output devices or combination input/output devices, collectively I/O devices 254. The I/O devices 254 may include a keyboard or keypad, pointing device, such as a mouse, disk drives and any other devices to permit a user, such as user 223, to interface with and control operation of the computing device 224 and to access the messaging application 240 and/or attention management module 212 on the attention management system 202. The I/O devices 254 may also include at least one device configured to read computer code from a computer program product, such as computer program product 222.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of embodiments of the invention. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Furthermore, when it is said herein that something is “based on” something else, it may be based on one or more other things as well. In other words, unless expressly indicated otherwise, as used herein “based on” means “based at least in part on” or “based at least partially on.”

The corresponding structures, materials, acts, and equivalents of all means or step plus function elements in the claims below are intended to include any structure, material, or act for performing the function in combination with other claimed elements as specifically claimed. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although specific embodiments have been illustrated and described herein, those of ordinary skill in the art appreciate that any arrangement which is calculated to achieve the same purpose may be substituted for the specific embodiments shown and that embodiments of the invention have other applications in other environments. This application is intended to cover any adaptations or variations of the present invention. The following claims are in no way intended to limit the scope of embodiments of the invention to the specific embodiments described herein.

What is claimed is:

1. A computerized method for providing group-based attention management of electronic messages, comprising:
receiving, by a computer processor, an electronic message, the electronic message defining a plurality of recipients;
identifying, by a computer processor, one or more candidate tuples from the plurality of recipients;
comparing, by a computer processor, the one or more candidate tuples with one or more stored tuples to identify one or more relevant tuples from the candidate tuples;
based on the one or more relevant tuples, determining, by a computer processor, an attention score for one or more of the plurality of recipients; and
based on the attention score for one or more of the plurality of recipients, modifying, by a computer processor, the presentation of the electronic message to one or more of the plurality of recipients.

2. The method of claim 1, wherein comparing the one or more candidate tuples with one or more stored tuples to identify one or more relevant tuples from the candidate tuples is based on comparing members of the one or more candidate tuples to members of the one or more stored tuples.

3. The method of claim 1, wherein comparing the one or more candidate tuples with one or more stored tuples to identify one or more relevant tuples from the candidate tuples is based on analyzing a message history associated with the one or more stored tuples.

4. The method of claim 1, wherein comparing the one or more candidate tuples with one or more stored tuples to identify one or more relevant tuples from the candidate tuples is based on determining whether a tuple participation index associated with the one or more stored tuples exceeds a threshold.

5. The method of claim 1, wherein determining an attention score for one or more of the plurality of recipients is based on analyzing a message history associated with members of the one or more relevant tuples.

6. The method of claim 1, wherein determining an attention score for one or more of the plurality of recipients is based on analyzing an interaction history between members of the one or more relevant tuples and a sender of the electronic message.

7. The method of claim 1, wherein determining an attention score for one or more of the plurality of recipients is based on (i) performing natural language processing of the electronic message and/or (ii) analyzing message metadata associated with the electronic message.

8. The method of claim 1, comprising, based on the one or more relevant tuples, determining a confidence score of each attention score for one or more of the plurality of recipients;
wherein modifying the presentation of the electronic message to one or more of the plurality of recipients is further based on the confidence score of each attention score for one or more of the plurality of recipients.

9. The method of claim 1, wherein modifying the presentation of the electronic message to one or more of the plurality of recipients comprises increasing a message priority for a first recipient and decreasing a message priority for a second recipient.

10. The method of claim 1, comprising determining that a message volume exceeds a threshold;
wherein, based on determining that the message volume exceeds a threshold, (i) determining an attention score for one or more of the plurality of recipients is further based on secondary criteria and/or (ii) modifying the presentation of the electronic message to one or more of the plurality of recipients is further based on the secondary criteria.

11. A system for providing group-based attention management of electronic messages, comprising:
a processor;
a memory;
an attention management module, executable by the processor and configured for:
receiving an electronic message, the electronic message defining a plurality of recipients;
identifying one or more candidate tuples from the plurality of recipients;
comparing the one or more candidate tuples with one or more stored tuples to identify one or more relevant tuples from the candidate tuples;
based on the one or more relevant tuples, determining an attention score for one or more of the plurality of recipients; and
based on the attention score for one or more of the plurality of recipients, modifying the presentation of the electronic message to one or more of the plurality of recipients.

12. The system of claim 11, wherein comparing the one or more candidate tuples with one or more stored tuples to identify one or more relevant tuples from the candidate tuples is based on comparing members of the one or more candidate tuples to members of the one or more stored tuples.

13. The system of claim 11, wherein comparing the one or more candidate tuples with one or more stored tuples to identify one or more relevant tuples from the candidate tuples is based on analyzing a message history associated with the one or more stored tuples.

14. The system of claim 11, wherein determining an attention score for one or more of the plurality of recipients is based on analyzing a message history associated with members of the one or more relevant tuples.

15. The system of claim 11, wherein modifying the presentation of the electronic message to one or more of the plurality of recipients comprises increasing a message priority for a first recipient and decreasing a message priority for a second recipient.

16. A computer program product for providing group-based attention management of electronic messages comprising a non-transitory computer-readable storage medium having computer-executable instructions for:
receiving an electronic message, the electronic message defining a plurality of recipients;
identifying one or more candidate tuples from the plurality of recipients;
comparing the one or more candidate tuples with one or more stored tuples to identify one or more relevant tuples from the candidate tuples;
based on the one or more relevant tuples, determining an attention score for one or more of the plurality of recipients; and
based on the attention score for one or more of the plurality of recipients, modifying the presentation of the electronic message to one or more of the plurality of recipients.

17. The computer program product of claim 16, wherein comparing the one or more candidate tuples with one or more stored tuples to identify one or more relevant tuples from the candidate tuples is based on comparing members of the one or more candidate tuples to members of the one or more stored tuples.

18. The computer program product of claim 16, wherein comparing the one or more candidate tuples with one or more stored tuples to identify one or more relevant tuples from the candidate tuples is based on analyzing a message history associated with the one or more stored tuples.

19. The computer program product of claim 16, wherein determining an attention score for one or more of the plurality of recipients is based on analyzing a message history associated with members of the one or more relevant tuples.

20. The computer program product of claim 16, wherein modifying the presentation of the electronic message to one or more of the plurality of recipients comprises increasing a message priority for a first recipient and decreasing a message priority for a second recipient.
